(19) United States
(12) Patent Application Publication
(10) Pub. No.: US 2005/0229490 A1
(43) Pub. Date: Oct. 20, 2005

(54) Reactor and apparatus for hydrogen generation

(75) Inventors: James F. Stevens, Katy, TX (US); Jerry M. Rovner, Houston, TX (US)

Correspondence Address: FRANK C. TURNER;CHEVRON SERVICES COMPANY, LAW DEPARTMENT, P.O. BOX 3725, HOUSTON, TX, 77253-3725, US

(73) Assignees: TEXACO INC., San Ramon, CA (US); TEXACO DEVELOPMENT CORPORATION, San Ramon, CA (US)

(21) Appl. No.: 10/827,580

(22) Filed: Apr. 19, 2004

(51) Int. Cl. B01J 8/00

(52) U.S. Cl. 48/198.7; 48/127.9; 48/128; 48/95

(57) ABSTRACT

Apparatus and methods for converting hydrocarbon fuels to hydrogen-rich reformate that incorporate a carbon dioxide fixing mechanism into the initial hydrocarbon conversion process. The mechanism utilizes a carbon dioxide fixing material within the reforming catalyst bed to remove carbon dioxide from the reformate product. The removal of carbon dioxide from the product stream shifts the reforming reaction equilibrium toward higher hydrocarbon conversion with only small amounts of carbon oxides produced. Fixed carbon dioxide may be released by heating the catalyst bed to a calcination temperature. Heat for releasing fixed carbon dioxide from the catalyst bed is generated internally within the reactor through oxidation. A non-uniform distribution of catalysts and carbon dioxide fixing material across catalyst bed can be utilized to achieve higher conversion rates of hydrocarbon to hydrogen-rich reformate.

### FIELD OF THE INVENTION

The present invention relates to the field of fuel processing wherein hydrocarbon-based fuels are converted to a hydrogen-enriched reformate for ultimate use in hydrogen-consuming devices and processes. The fuel processing methods of the present invention provide a hydrogen-rich reformate of high purity by utilizing absorption enhanced reforming wherein a by-product, such as carbon dioxide, is absorbed or removed from the product stream to shift the conversion reaction equilibrium toward higher hydrocarbon conversion rates with smaller amounts of by-products produced.

### BACKGROUND OF THE INVENTION

Hydrogen is utilized in a wide variety of industries ranging from aerospace to food production to oil and gas production and refining. Hydrogen is used in these industries as a propellant, an atmosphere, a carrier gas, a diluent gas, a fuel component for combustion reactions, a fuel for fuel cells, as well as a reducing agent in numerous chemical reactions and processes. In addition, hydrogen is being considered as an alternative fuel for power generation because it is renewable, abundant, efficient, and unlike other alternatives, produces zero emissions. While there is wide-spread consumption of hydrogen and great potential for even more, a disadvantage which inhibits further increases in hydrogen consumption is the absence of a hydrogen infrastructure to provide widespread generation, storage and distribution. One way to overcome this difficulty is through distributed generation of hydrogen, such as through the use of fuel reformers to convert a hydrocarbon-based fuel to a hydrogen-rich reformate.

Fuel reforming processes, such as steam reforming, partial oxidation, and autothermal reforming, can be used to convert hydrocarbon fuels such as natural gas, LPG, gasoline, and diesel, into hydrogen-rich reformate at the site where the hydrogen is needed. However, in addition to the desired hydrogen product, fuel reformers typically produce undesirable impurities that reduce the value of the reformate product. For instance, in a conventional steam reforming process, a hydrocarbon feed, such as methane, natural gas, propane, gasoline, naphtha, or diesel, is vaporized, mixed with steam, and passed over a steam reforming catalyst. The majority of the hydrocarbon feed is converted to a mixture of hydrogen and impurities such as carbon monoxide and carbon dioxide. The reformed product gas is typically fed to at least one water-gas shift bed in which the carbon monoxide is reacted with steam to form carbon dioxide and hydrogen. After the shift reaction(s), additional purification steps are required to bring the reformate purity to acceptable levels. These steps can include, but are not limited to, methanation, selective oxidation reactions, passing the product stream through membrane separators, as well as pressure swing and temperature swing absorption processes. While such purification technologies may be known, the added cost and complexity of integrating them with a fuel reformer to produce sufficiently pure hydrogen reformate can render their construction and operation impractical.

In terms of power generation, fuel cells typically employ hydrogen as fuel in catalytic oxidation-reduction reactions to produce electricity. As with most industrial applications utilizing hydrogen, the purity of the hydrogen used in fuel cell systems is critical. Specifically, because power generation in fuel cells is proportional to the consumption rate of the reactants, the efficiencies and costs of fuel cells can be improved through the use of highly pure hydrogen reformate. Moreover, the catalysts employed in many types of fuel cells can be deactivated or permanently impaired by exposure to certain impurities that are commonly found in conventionally reformed fuels. As a result, an improved yet simplified reforming apparatus and process capable of providing a high purity hydrogen reformate that is low in carbon oxides is greatly desired.

The disclosure of U.S. Pat. No. 6,682,838, issued to Stevens, Jan. 27, 2004, is incorporated herein by reference.

### SUMMARY OF THE INVENTION

In one aspect of the instant invention, a reforming reactor for producing a hydrogen reformate is provided. The reactor includes a reactor vessel having an inlet for receiving a hydrocarbon fuel and an outlet for delivering a hydrogen-rich reformate. Disposed within the reactor vessel is a catalyst bed that includes a reforming catalyst, a carbon dioxide fixing material and optionally a water gas shift catalyst. In some embodiments, the catalyst bed can have a non-uniform distribution of the reforming catalyst and carbon dioxide fixing material. Optionally, the reactor vessel can include catalyst bed support means for supporting the catalyst bed within the reactor vessel. The reactor further includes an oxidation zone disposed within the reactor vessel proximate the catalyst bed that is in fluid communication with the catalyst bed and optionally an oxidant inlet for directing an oxidant into the oxidation zone. The reactor vessel further includes a moderator inlet for introducing a temperature moderator into the oxidation zone. The reactor vessel can also include a side wall comprising a refractory material.

In another aspect of the instant invention, an apparatus for generating hydrogen is provided. The apparatus includes a desulfurization unit for removing sulfur-containing compounds from a hydrocarbon fuel and a reactor in fluid communication with the desulfurization unit for receiving the desulfurized fuel and producing a hydrogen-rich reformate. The reactor comprises a reactor vessel having an inlet for receiving a hydrocarbon fuel and an outlet for delivering a hydrogen-rich reformate. A catalyst bed is disposed within the reactor vessel that comprises a reforming catalyst, a carbon dioxide fixing material and optionally, a water gas shift catalyst. An oxidation zone is disposed within the reactor vessel proximate the catalyst bed that is in fluid communication with the catalyst bed. A moderator inlet is also provided on the reactor vessel for introducing a temperature moderator into the oxidation zone. The apparatus further includes a polishing unit in fluid communication with the outlet of the reactor vessel for removing one or more impurities from the hydrogen-rich reformate. Preferably, the polishing unit is selected from the group consisting of drying units, methanation reactors, selective oxidation reactors, pressure swing absorption units, temperature swing absorption units, membrane separators and combinations of the same.

In still another aspect of the instant invention, a reforming reactor for producing a hydrogen reformate is provided. The reactor includes a reactor vessel having an inlet for receiving a hydrocarbon fuel and an outlet for delivering a hydrogen-rich reformate. Disposed within the reactor vessel is a catalyst bed that includes a reforming catalyst, a carbon dioxide fixing material, and optionally, a water gas shift catalyst. In some embodiments, the catalyst bed can have a non-uniform distribution of the reforming catalyst and carbon dioxide fixing material. Optionally, the reactor vessel can comprise catalyst bed support means for supporting the catalyst bed within the reactor vessel. An oxidation zone is disposed downstream of the catalyst bed in fluid communication with the catalyst bed and can optionally include an oxidant inlet for directing an oxidant into the oxidation zone. A moderator inlet can optionally be included on the reactor vessel for introducing a temperature moderator into the oxidation zone. The reactor vessel can also include a side wall comprising a refractory material.

In yet another aspect of the present invention, an apparatus for generating hydrogen is provided. The apparatus includes a desulfurization unit for removing sulfur-containing compounds from a hydrocarbon fuel and a reactor in fluid communication with the desulfurization unit for receiving the desulfurized fuel and producing a hydrogen-rich reformate. The reactor comprises a reactor vessel having an inlet for receiving a hydrocarbon fuel and an outlet for delivering a hydrogen-rich reformate. A catalyst bed is disposed within the reactor vessel that comprises a reforming catalyst, a carbon dioxide fixing material and optionally a water gas shift catalyst. An oxidation zone is disposed within the reactor vessel downstream of the catalyst bed that is in fluid communication with the catalyst bed. The apparatus further includes a polishing unit in fluid communication with the reactor vessel that is disposed downstream from the reactor vessel for removing one or more impurities from the hydrogen-rich reformate. Preferably, the polishing unit is selected from the group consisting of drying units, methanation reactors, selective oxidation reactors, pressure swing absorption units, temperature swing absorption units, membrane separators and combinations thereof.

In a process aspect of the instant invention, a method for producing a hydrogen-rich reformate in a reactor having a catalyst bed comprising a reforming catalyst and carbon dioxide fixing material is provided. The method includes the steps of converting a hydrocarbon fuel within the catalyst bed to a reformate comprising hydrogen and carbon dioxide. In some embodiments, the method can further include removing sulfur from the hydrocarbon fuel and/or directing steam into the reactor so that the hydrocarbon fuel is converted with the steam over the catalyst bed to a reformate. Preferably, the hydrocarbon fuel is converted at a steam reforming temperature between about 400° C. and about 800° C., more preferably, between about 450° C. and about 750° C. and still more preferably, between about 500° C. and about 700° C. The carbon dioxide fixing material within the catalyst bed fixes at least a portion of the carbon dioxide in the reformate to produce a hydrogen-rich reformate and fixed carbon dioxide. The hydrogen-rich reformate is removed from the catalyst bed and optionally, directed to a polishing unit to remove one or more impurities from the hydrogen-rich reformate.

A hydrocarbon fuel is oxidized within the reactor to produce heated oxidation products. Preferably, the hydrocarbon fuel is oxidized with an oxidant non-catalytically. The method further includes the step of adjusting the temperature of the heated oxidation products with a flow of a temperature moderator. Preferably, the temperature moderator is a fluid material selected from the group consisting of steam, water, air, carbon dioxide, nitrogen and mixtures of the same. The carbon dioxide fixing material is heated with the heated oxidation products to a temperature at which at least a portion of the fixed carbon dioxide is released to provide a carbon dioxide-laden gas and heated carbon dioxide fixing material. Preferably, the carbon dioxide fixing material is heated to a temperature between about 500° C. and about 900° C., more preferably, between about 550° C. and about 850° C., and still more preferably, between about 600° C. and about 800° C.

The method can optionally include one or more of the steps of interrupting the oxidation of the oxidant, removing carbon dioxide-laden gas from the reactor vessel and resuming the conversion of the hydrocarbon fuel to reformate. In some embodiments, the heated carbon dioxide fixing material is hydrated with steam prior to resuming reforming. When used, preferably the steam comprises a low temperature steam having a temperature below about 500° C., preferably below about 400° C., more preferably below about 300° C., and still more preferably below about 200° C. The method can also optionally include purging the reactor with a small volume of high temperature steam prior to oxidizing the hydrocarbon fuel and/or after interrupting the oxidation of the hydrocarbon fuel.

### BRIEF DESCRIPTION OF THE DRAWINGS

The invention may be understood by reference to the following description taken in conjunction with the accompanying drawings.

FIG. 1 is a simplified cross sectional view of a reforming reactor of the instant invention.

FIG. 2 is a simplified cross sectional view of a reforming reactor of the instant invention.

FIG. 3 is a simplified cross sectional view of a reforming reactor of the instant invention.

FIG. 4 is a schematic diagram of an apparatus of the instant invention.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF THE PREFERRED EMBODIMENTS

Illustrative embodiments of the invention are described below. In the interest of clarity, not all features of an actual embodiment are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover it will be appreciated that such a development effort might be complex and time-consuming, but would nevertheless be a routine undertaking for those of ordinary skill in the art having the benefit of this disclosure.

The instant invention is generally directed to reactors, apparatuses and methods for converting a hydrocarbon-based fuel to a hydrogen-rich reformate. The invention simplifies the production of a highly pure hydrogen-rich reformate by incorporating a carbon dioxide fixing mechanism into the initial hydrocarbon conversion process. This mechanism utilizes a carbon dioxide fixing material within the reforming catalyst bed that will react with and/or retain carbon dioxide under reaction conditions that are typical for conversion reactions of hydrocarbon to hydrogen and carbon oxides. Hydrocarbon to hydrogen conversion reactions that utilize such carbon dioxide fixing materials are generally referred to herein as “absorption enhanced reforming” as the absorption or removal of carbon dioxide from the reformed product shifts the reforming reaction equilibrium toward the production of higher levels of hydrogen and lower levels of carbon oxides.

Absorption enhanced reforming generates a hydrogen-rich reformate by conducting multiple reactions within a common catalyst bed. Typical reactions that may be performed within the catalyst bed include fuel reforming reactions such as steam and/or autothermal reforming reactions that generate a reformate containing hydrogen, carbon oxides and potentially other impurities, water gas shift reactions wherein water and carbon monoxide are converted to hydrogen and carbon dioxide, and carbonation reactions wherein carbon dioxide is physically absorbed or chemically converted to preferably a non-gaseous species. Chemical equations for such a combination of reactions using methane as the hydrocarbon fuel and calcium oxide as the carbon dioxide fixing material are as follows:

| | | |
|---|---|---|
| CH₄ + H₂O → + 3H₂ + CO | (Steam Reforming) | (I) |
| H₂O + CO → H₂ + CO₂ | (Water Gas Shift) | (II) |
| CO₂ + CaO → CaCO₃ | (Carbonation) | (III) |
| CH₄ + 2H₂O + CaO → 4H₂ + CaCO₃ | (Combined) | (IV) |

While these equations exemplify the conversion of methane to a hydrogen-rich reformate, the scope of the invention should not be so limited.

Carbon dioxide fixing materials are typically caused to desorb or evolve carbon dioxide by application of a change in temperature, pressure or a combination of changes in temperature and pressure. For instance, it is known that fixed carbon dioxide can be liberated from many carbon dioxide fixing materials by temporarily elevating the temperature of the fixing material. However, such processes can be highly endothermic depending on the type of fixing material employed, and thus, are often thermally inefficient. Another concern is the risk that the heating of the carbon dioxide fixing material may degrade or otherwise deactivate other components within the catalyst bed, namely, the reforming catalyst. Moreover, care should be taken to assure that such processes do not result in the deposition of materials within the catalyst bed that can inhibit the activity of the catalyst(s) or other bed components.

A reactor of the instant invention comprises a reactor vessel having an inlet for receiving a hydrocarbon fuel and an outlet for delivering a hydrogen-rich reformate. The inlet of the reactor vessel is preferably connected to sources of hydrocarbon fuel and steam. Optionally, where a hydrocarbon fuel to be utilized in the reactor vessel comprises sulfur-containing compounds, a desulfurization unit can be connected to the vessel to reduce the sulfur content of the fuel. A source of air, oxygen, or oxygen-enriched air can be connected to the reactor vessel, such as where the intended reforming reaction is an autothermal reforming reaction. Separate inlets for hydrocarbon fuel(s), steam, and/or air may be utilized, or in an alternative, two or more of such materials may be combined and mixed outside the reactor vessel and introduced as a mixture through a common inlet. Heated mixtures of hydrocarbon fuel and oxidants should be avoided so as to an undesired oxidation of the materials.

The reactor vessel includes a catalyst bed disposed within the vessel that comprises a reforming catalyst, preferably a steam reforming catalyst, an optional water gas shift catalyst, and a carbon dioxide fixing material.

The reforming catalyst(s) may be in any form including pellets, spheres, extrudates, monoliths, as well as common particulates and agglomerates. Conventional steam reforming catalysts are well known in the art and can include nickel with amounts of cobalt or a noble metal such as platinum, palladium, rhodium, ruthenium, and/or iridium. The catalyst can be supported, for example, on magnesia, alumina, silica, zirconia, or magnesium aluminate, singly or in combination. Alternatively, the steam reforming catalyst can include nickel, preferably supported on magnesia, alumina, silica, zirconia, or magnesium aluminate, singly or in combination, promoted by an alkali metal such as potassium. Where the reforming reaction is preferably a steam reforming reaction, the reforming catalyst preferably comprises rhodium on an alumina support. Suitable reforming catalysts are commercially available from companies such as Cabot Superior Micropowders LLC (Albuquerque, N. Mex.) and Engelhard Corporation (Iselin, N.J.).

Certain reforming catalysts have been found to exhibit activity for both reforming and water gas shift reactions. In particular, it has been found that a rhodium catalyst on alumina support will catalyze both a steam methane reforming reaction and a water gas shift reaction under the conditions present in the catalyst bed. In such circumstances, the use of a separate water gas shift catalyst is not required. Where the selected reforming catalyst does not catalyze the shift reaction, the catalyst bed comprises a separate water gas shift catalyst.

Reaction temperatures of an autothermal reforming reaction can range from about 550° C. to about 900° C. depending on the feed conditions and the catalyst. In a preferred embodiment, the reforming reaction is a steam reforming reaction with a reforming temperature in the range from about 400° C. to about 800° C., preferably in the range from about 450° C. to about 700° C., and more preferably in the range from about 500° C. to about 650° C. Reforming reaction temperatures can be achieved by flowing gas(es) such as heated streams of helium, nitrogen, steam, as well as heated exhaust gases from a fuel cell or the tail gas of a metal hydride storage system through the catalyst bed. In an alternative, heat exchanging means as described herein can also be used. Suitable heat exchanging means will be capable of raising the bed temperature to a reforming temperature and/or to a calcination temperature although it is preferred that the heat used to calcinate the carbon dioxide fixing material be derived from the described oxidation reaction. When used, heat exchanging means can also be used to pre-heat reactant feeds to the catalyst bed(s).

A water gas shift catalyst can be used within the catalyst bed to promote the conversion of steam and carbon monoxide to hydrogen and carbon dioxide. The consumption of carbon monoxide by a shift reaction upgrades the value of the hydrogen-rich reformate gas as carbon monoxide is a well known poison to many catalyst systems including those used in fuel cells and petrochemical refining. The maximum level of carbon monoxide in the hydrogen-rich reformate should be a level that can be tolerated by fuel cells, a level that is typically below about 50 ppm. In addition, there is growing demand for even higher purity hydrogen reformate streams that have carbon monoxide concentrations below about 25 ppm, preferably below about 15 ppm, more preferably below 10 ppm, and still more preferably below about 5 ppm.

Water gas shift reactions generally occur at temperatures of from about 150° C. to about 600° C. depending on the catalyst used. Low temperature shift catalysts operate at a range of from about 150° C. to about 300° C. and include for example, copper oxide, or copper supported on other transition metal oxides such as zirconia, zinc supported on transition metal oxides or refractory supports such as silica, alumina, zirconia, etc., or a noble metal such as platinum, rhenium, palladium, rhodium or gold on a suitable support such as silica, alumina, zirconia, and the like. High temperature shift catalysts are preferably operated at temperatures ranging from about 300° C. to about 600° C. and can include transition metal oxides such as ferric oxide or chromic oxide, and optionally include a promoter such as copper or iron silicide. Suitable high temperature shift catalysts also include supported noble metals such as supported platinum, palladium and/or other platinum group members. Suitable water gas shift catalysts are commercially available from companies such as Cabot Superior Micropowders LLC (Albuquerque, N. Mex.) and Engelhard Corporation (Iselin, N.J.).

The catalyst bed will also include a carbon dioxide fixing material. As used in this disclosure, “carbon dioxide fixing material” is intended to refer to materials and substances that react or bind with carbon dioxide at a temperature within the range of temperatures that is typical of hydrocarbon conversion to hydrogen and carbon oxides. Such carbon dioxide fixing materials include, but are not limited to, those materials that will adsorb or absorb carbon dioxide as well as materials that will convert carbon dioxide to a chemical species that is more easily removed from the reformate gas stream. In addition, suitable fixing materials will need to be stable in the presence of steam at reforming temperatures, can maintain a high carbon dioxide fixing capacity over multiple reforming/calcination cycles, are low in toxicity and pyrophoricity, and will preferably be low in cost.

Suitable carbon dioxide fixing materials can comprise an alkaline earth oxide(s), a doped alkaline earth oxide(s) or mixtures thereof. Preferably, the carbon dioxide fixing material will comprise calcium, strontium, or magnesium salts combined with binding materials such as silicates or clays that prevent the carbon dioxide fixing material from becoming entrained in the gas stream and reduce crystallization that decreases surface area and carbon dioxide absorption. Salts used to make the initial bed can be any salt, such as an oxide or hydroxide that will convert to the carbonate under process conditions. Specific substances that are capable of fixing carbon dioxide in suitable temperature ranges include, but are not limited to, calcium oxide (CaO), calcium hydroxide (Ca(OH)₂), strontium oxide (SrO), strontium hydroxide (Sr(OH)₂) and mixtures thereof.

Other suitable carbon dioxide fixing materials can include those materials described in U.S. Pat. No. 3,627,478 issued Dec. 14, 1971 to Tepper, (describing the use of weak base ion exchange resins at high pressure to absorb CO₂); U.S. Pat. No. 6,103,143 issued Aug. 15, 2000 to Sircar et al., (describing a preference for the use of modified double layered hydroxides represented by the formula [Mg₍₁₋ₓ₎Alₓ(OH)₂][CO₃]_{x/2yH2}O.zM′₂CO₃ where 0.09≦x≦0.40, 0≦y≦3.5, 0≦z≦3.5 and M′=Na or K, and spinels and modified spinels represented by the formula Mg[Al₂]O₄.yK₂CO₃ where 0≦y≦3.5); U.S. Patent Application Publication No. 2002/0110503 A1 published Aug. 15, 2002 by Gittleman et al., (describing the use of metal and mixed metal oxides of magnesium, calcium, manganese, and lanthanum and the clay minerals such as dolomite and sepiolite); and U.S. Patent Application Publication No. 2003/0150163 A1 published Aug. 14, 2003 by Murata et al., (describing the use of lithium-based compounds such as lithium zirconate, lithium ferrite, lithium silicate, and composites of such lithium compounds with alkaline metal carbonates and/or alkaline earth metal carbonates); the disclosures of each of which are incorporated herein by reference. In addition, suitable mineral compounds such as allanite, andralite, ankerite, anorthite, aragoniter, calcite, dolomite, clinozoisite, huntite, hydrotalcite, lawsonite, meionite, strontianite, vaterite, jutnohorite, minrecordite, benstonite, olekminskite, nyerereite, natrofairchildite, farichildite, zemkorite, butschlite, shrtite, remondite, petersenite, calcioburbankite, burbankite, khanneshite, carboncemaite, brinkite, pryrauite, strontio dressenite, and similar such compounds and mixtures thereof, can be suitable materials for fixing carbon dioxide.

One or more of the described carbon dioxide fixing materials may be preferred depending on such variables as the hydrocarbon fuel to be reformed, the selected reforming reaction conditions and the specification of the hydrogen-rich gas to be produced. In addition, the fixing material selected should exhibit low equilibrium partial pressure of carbon dioxide in the temperature range of about 400° C. to about 650° C. and high equilibrium partial pressure of carbon dioxide at temperatures from about 150° C. to about 400° C. above the selected reforming reaction temperature.

The carbon dioxide fixing material may take any of the forms suggested above for catalysts, including pellets, spheres, extrudates, monoliths, as well as common particulates and agglomerates. In addition, the catalyst(s) and carbon dioxide fixing material may be combined into a mixture in one or more of the forms suggested above. In a preferred embodiment, the carbon dioxide fixing material will be combined with catalyst(s) to form a mixture that is processed into a particulate using an aerosol method such as that disclosed in U.S. Pat. No. 6,685,762 issued Feb. 3, 2004 to Brewster et al., the contents of which are incorporated herein by reference.

Although conventional catalyst beds having multiple components tend to have a uniform distribution of components along the reactants' pathway through the bed, it has been found that superior conversion rates can be achieved with absorption enhanced reforming where the catalyst(s) and carbon dioxide fixing materials have a non-uniform distribution within the bed. Generally, the catalyst composition nearest the bed inlet should contain an amount of reforming catalyst that is greater than the average level of reforming catalyst across the bed. In contrast, the composition nearest the bed outlet should contain an amount of reforming catalyst that is less than the average level of reforming catalyst across the bed. In a preferred embodiment, the non-uniform distribution will provide no reforming catalyst proximate the bed outlet as there would be little opportunity for carbon dioxide produced by a reforming reaction at such a location to be fixed before the reformate product exits the bed.

In some embodiments, a non-uniform distribution of reforming catalyst can be achieved by providing a generally smooth distribution of reforming catalyst that decreases across the bed from the inlet to the outlet. In other embodiments, a non-uniform distribution of reforming catalyst can be achieved by providing a plurality of reaction zones that have generally decreasing concentrations of reforming catalyst ranging from the inlet to the outlet. A more specific example of a zoned approach is to provide a catalyst bed with a plurality of reaction zones that include an inlet zone located proximate the bed inlet, an outlet zone located proximate the bed outlet, and one or more optional intermediate zones disposed between the inlet and outlet zones. In such embodiments, the inlet zone comprises reforming catalyst, an optional water gas shift catalyst, but preferably no carbon dioxide fixing material. Further, the outlet zone comprises carbon dioxide fixing material and an optional but highly preferred water gas shift catalyst, but no reforming catalyst. A more detailed description of a catalyst beds having a non-uniform distribution of bed components may be found in U.S. patent application Ser. No. ______ “Reactor with Carbon Dioxide Fixing Material,” Stevens, et al., filed Apr. 16, 2004 (Attorney Docket No. X-0148), the contents of which are incorporated herein by reference.

Preferably, the catalyst bed is a fixed bed such that the carbon dioxide fixing material is not be withdrawn for the purpose of releasing fixed carbon dioxide but is heated in situ within the reforming catalyst bed.

Catalyst bed support means for supporting the catalyst bed within the reactor vessel can also be utilized. Catalyst bed support means will include inert support materials such as various ceramic materials that may be loaded into the reactor vessel below the catalyst bed. In addition, catalyst bed support means can also include refractory bricks or perforated support members that span the reactor and provide support for any support materials and the catalyst bed. Depending on the requirements of the end user of the hydrogen to be produced, the pressure of the hydrogen-rich reformate at the outlet of the reactor vessel can also be important. As such, the selection and installation of catalyst bed support means within the lower portion of the reactor vessel should take into consideration the pressure drop that may be imposed.

Heat exchanging means for removing heat from and/or delivering heat to the catalyst bed can optionally be incorporated into the design of the catalyst bed, the catalyst bed support means, imbedded amongst the catalyst bed components or disposed elsewhere within the reactor depending on its specific function. Such heat exchanging means are primarily intended for use in achieving and maintaining the catalyst bed at a desired reaction temperature. In a preferred embodiment, the heat exchanging means are used for maintaining the catalyst bed a reforming reaction temperature as the heat required for heating the carbon dioxide fixing material to a calcination temperature is more efficiently provided by the oxidation of a hydrocarbon fuel within the oxidation zone as described herein.

Suitable heat exchanging means can include those capable of generating heat such as electrically resistant heating coils that are in contact with the catalyst bed. Alternative suitable heat exchanging means comprise heat transfer devices in contact with the catalyst bed that are operably coupled with separate heat generating means. For instance, in a preferred embodiment, the heat exchanging means comprise a heat exchange coil or heat pipe operably coupled to heat generating means that is capable of providing variable heat so that the amount of heat delivered to the catalyst bed can be adjusted to achieve the appropriate reforming or calcination temperature. Suitable heat generating means can include conventional heating units such as resistant heating coils, burners or combustors, as well as fuel cell and/or hydrogen storage system that produce heated exhaust gases.

In some embodiments, two or more heat generating means can be used to provide heat within different temperature ranges. More specifically, one heat generating means generates heat for heating the catalyst bed to a reforming reaction temperature and a second heat generating means generates heat for heating a catalyst bed to a calcinating temperature. Where two or more reforming catalyst beds are utilized such that one bed is in reforming mode while simultaneously a second bed is heated to a calcination temperature, it is preferred that the two heat generating means be thermally integrated so as to improve the thermal efficiency of the total system. Thermal integration can be achieved by pre-heating reforming reactant feeds such as hydrocarbon fuel and steam with excess heat generated for heating the second catalyst bed to a calcination temperature. Where the heat generating means comprise a burner or combustor, oxidant(s) to be reacted in the heat generating means can likewise be pre-heated to improve the thermal efficiency of the overall reformer system.

The heating of the catalyst bed for purposes of the reforming reaction and/or calcination reaction can be achieved by providing a continuous supply of heat to the bed that is sufficient to achieve and maintain the desired temperature throughout the reaction. In some embodiments, the bed is initially heated to the desired reaction temperature with heating thereafter discontinued as the reaction proceeds. In such an embodiment, the bed temperature is monitored and additional heat provided if needed to maintain a desired reaction temperature.

An oxidation zone is disposed within the reactor vessel that is in fluid communication with the catalyst bed. As noted above, the heat for heating the carbon dioxide fixing material to a calcination temperature is preferably generated by an oxidation reaction occurring within the reactor vessel. However, so that carbon or other oxidation by-products are not deposited within the catalyst bed, it is highly preferred that the oxidation reaction occur within an oxidation zone external to the catalyst bed.

When the oxidation zone is disposed upstream of the catalyst bed such that the heated oxidation products flow through the catalyst bed, the reactor further includes a moderator inlet for introducing a temperature moderator into the oxidation zone for controlling the oxidation reaction and/or adjusting the temperature of the heated oxidation products. When the oxidation zone is disposed downstream from the catalyst bed and oxidation products do not flow through the catalyst bed, a moderator inlet is an optional feature of the reactor.

In an optional but highly preferred embodiment, the reactor vessel comprises an oxidant inlet for directing oxidant into the oxidation zone. In other embodiments, an ignition source such as a spark plug or the like can optionally be disposed within the oxidation zone for initiating the oxidation reaction. In embodiments where heated oxidation products do not flow through the catalyst bed, heat exchanging means as described herein can be used to facilitate the transfer of heat between the catalyst bed and the oxidation zone. In addition, the reactor vessel can optionally comprise thermocouples or other temperature sensing means for monitoring temperatures at various locations within the reactor vessel.

Reactor vessels and other process equipment described herein may be fabricated from any material capable of withstanding the operating conditions and chemical environment of the reactions described, and can include, for example, carbon steel, stainless steel, Inconel, Incoloy, Hastelloy, and the like. Preferably, the reactor vessel will have a side wall that comprises a refractory material such as a ceramic type refractory material including but not limited to silicon carbide, silicon nitride or any other suitable known advanced ceramic composite. The operating pressure for the reactor vessel and other process units are preferably from about 0 to about 100 psig, although higher pressures may be employed. Ultimately, the operating pressure of the fuel processor depends upon the delivery pressure required by the users of the hydrogen produced. Where the hydrogen is to be delivered to a fuel cell operating in the 1 to 20 kW range, an operating pressure of 0 to about 100 psig is generally sufficient. Higher pressure conditions may be required depending on the hydrogen requirements of the end user. As described in additional detail below, the operating temperatures within the reactor vessel will vary depending on the type reforming reaction, the type of reforming catalyst, the carbon dioxide fixing material, a water gas shift catalyst when used, and selected pressure conditions among other variables.

In some embodiments of the instant invention, a reactor is a component of an apparatus for generating a hydrogen-rich reformate.

In one such embodiment, the apparatus comprises a desulfurization unit for removing sulfur-containing compounds from the hydrocarbon fuel prior to any use of the hydrocarbon fuel within reactor vessel. In a preferred embodiment, the desulfurization unit will remove all of the sulfur-containing compounds that may be present in the fuel. Devices and systems for removing sulfur-containing compounds from hydrocarbon fuels are well known in the petrochemical arts. The desulfurization unit preferably comprises an absorbent and/or catalyst bed for removing sulfur from a hydrocarbon fuel flowing through the bed. Suitable desulfurization sorbents and catalysts can comprise alkali salts such as alkali metal compounds including metal oxides, silica based compounds including zeolites, activated alumina, activated carbon, compounds and composites of metals such as nickel, cobalt, iron, manganese, tungsten, silver, gold, copper, platinum, zinc, tin, ruthenium, molybdenum, antimony, vanadium iridium, platinum, chromium and palladium, and various inerts and support materials. Additional detail concerning desulfurization devices and systems may be found in U.S. Pat. No. 5,059,406 issued Oct. 22, 1991 to Sheth, et al.; U.S. Pat. No. 6,454,935 B1 issued Sep. 24, 2002 to Lesieur, et al.; U.S. Patent Application Publication No. 2003/0113598 A1, published Jun. 19, 2003 by Chow, et al.; U.S. Patent Application Publication No. 2003/0188993 A1, published Oct. 9, 2003 by Khare, et al.; and U.S. Patent Application Publication No. 2004/0063576 A1, published Apr. 1, 2004 by Chow, et al., the descriptions of each of which is incorporated herein by reference. The apparatus of the instant invention preferably includes a desulfurization unit having a bed comprising zinc oxide.

The apparatus further comprises a reactor that is in fluid communication with the desulfurization unit for receiving the desulfurized fuel. The reactor comprises a reactor vessel having an inlet for receiving the desulfurized fuel and an outlet for delivering a hydrogen-rich reformate. A catalyst bed is disposed within the reactor vessel that comprises a reforming catalyst and a carbon dioxide fixing material. An oxidation zone is disposed within the reactor vessel proximate to and in fluid communication with the catalyst bed. A moderator inlet is provided for introducing a temperature moderator into the oxidation zone in order to control the oxidation reaction and the temperature of the heated oxidation products produced within the oxidation zone.

The apparatus further includes a polishing unit that is in fluid communication with the reactor vessel. The polishing unit is disposed downstream from the reactor vessel for removing one or more impurities from the hydrogen-rich reformate. Preferably, the polishing unit is selected from the group consisting of drying units, methanation reactors, selective oxidation reactors, pressure swing absorption units, temperature swing absorption units and membrane separators. In some embodiments, the polishing unit is a methanation reactor for converting carbon oxides and hydrogen to methane. Because the level of carbon oxides in the hydrogen-rich reformate is particularly low, the amount of hydrogen that is required to convert the carbon oxides to methane is not considered to be significant. Further, methane can remain in the hydrogen-rich reformate stream without creating a deleterious effect on catalyst systems downstream. In other embodiments, the polishing unit comprises a drying unit for removing water from the hydrogen-rich reformate. In a preferred embodiment, the apparatus comprises a methanation reactor and a drying unit, wherein the methanation reactor is disposed upstream from the drying unit.

The apparatus can optionally comprise a purification bed comprising a hydrogen-fixing material for selectively removing or fixing hydrogen to produce fixed hydrogen within the bed and a hydrogen-depleted reformate that flows through and passes out of the bed. As the hydrogen fixing material becomes at least partially saturated with hydrogen, the flow of reformate can be diverted or interrupted and hydrogen released from the bed. The hydrogen fixing material is preferably a solid metal-hydride forming material and can optionally further comprise an inert material having a high heat capacity. A more detailed description of such a purification bed and its operation can be found in U.S. patent application entitled “Apparatus And Method For Hydrogen Generation” by Bavarian et al., filed Apr. 19, 2004 (Attorney Docket No. X-0170), the contents of which are incorporated herein by reference.

In some embodiments, the reformate generating apparatus can be coupled to a hydrogen storage device for providing a continuous supply of hydrogen-rich reformate as described in U.S. patent application entitled “Method And Apparatus For Providing A Continuous Stream Of Reformate,” by James F. Stevens, filed Apr. 19, 2004 (Attorney Docket No. X-0169), the contents of which are incorporated herein by reference.

In another embodiment the instant invention provides an apparatus for generating a hydrogen-rich reformate that comprises a desulfurization and polishing units as described herein, and a reactor comprising a reactor vessel having an inlet for receiving a desulfurized fuel and an outlet for delivering a hydrogen-rich reformate to the polishing unit. A catalyst bed is disposed within the reactor vessel that comprises a reforming catalyst and a carbon dioxide fixing material. In addition, an oxidation zone is disposed within the reactor vessel downstream of the catalyst bed that is in fluid communication with the catalyst bed. An oxidation reaction within the oxidation zone provides the heat for calcinating the carbon dioxide fixing material within the catalyst bed. Prefeably, the reactor will further comprise heat exchanging means for transferring heat between the oxidation zone and the catalyst bed. Optionally such an apparatus can comprise a purification bed and/or hydrogen storage device as also described herein.

The instant invention also provides a method for producing a hydrogen-rich reformate in a reactor having a catalyst bed comprising a reforming catalyst and carbon dioxide fixing material. Descriptions of suitable reactors, catalyst bed materials and the like are provided in detail above.

The method includes the step of converting a hydrocarbon fuel within the catalyst bed to a reformate comprising hydrogen and carbon oxides. As used herein the term “hydrocarbon fuel” includes organic compounds having C—H bonds which are capable of producing hydrogen from a partial oxidation, autothermal and/or a steam reforming reaction. The presence of atoms other than carbon and hydrogen in the molecular structure of the compound is not excluded. Thus, suitable fuels for use in the reactors and methods of the instant invention can include, but are not limited to, hydrocarbon fuels such as natural gas, methane, ethane, propane, butane, naphtha, gasoline, and diesel fuel, and alcohols such as methanol, ethanol, propanol, and the like. Preferably, the hydrocarbon fuel will be a gas at 30° C., standard pressure. More preferably the hydrocarbon fuel will comprise a component selected from the group consisting of methane, ethane, propane, butane, and mixtures of the same. In an optional but highly preferred embodiment, the hydrocarbon fuel is directed to a desulfurization unit to at least partially remove the sulfur-containing compounds from the fuel so that a desulfurized fuel is directed into the reactor vessel.

A source of water will also be operably connected to the reactor vessel. Water can be introduced to the reactor vessel as a liquid or vapor, but is preferably in the form of steam. The ratio of the reactor feeds are determined by the nature of the reaction and desired operating conditions as they affect both operating temperature and yield. In embodiments where the reforming reaction utilizes a steam reforming catalyst, the steam to carbon ratio is typically in the range between about 8:1 to about 1:1, preferably between about 5:1 to about 1.5:1 and more preferably between about 4:1 to about 2:1. When the catalyst bed is being operated in a non-reforming mode, such as when the carbon dioxide fixing material is being heated to a calcination temperature, the flow of steam to the bed will be reduced and in some embodiments interrupted. In addition, it should also be noted that steam temperature can vary depending on its purpose or the mode of operation of the reactor. For example, when small volumes of steam are optionally used to purge the reactor vessel prior to and/or following the oxidation of the hydrocarbon fuel, the steam temperature is preferably at a higher temperature approximate the selected reforming reaction temperature. When larger volumes of steam are used to hydrate the heated carbon dioxide fixing material, the steam will typically comprise a low temperature steam as described herein.

When the reforming reaction is a steam reforming reaction, hydrocarbon fuel and steam or a mixture of hydrocarbon fuel and steam are directed into the reactor vessel at a reforming temperature between about 400° C. and about 800° C., more preferably, between about 450° C. and about 750° C. and still more preferably, between about 500° C. and about 700° C. Where the reforming reaction is an autothermal reforming reaction, air, oxygen, or oxygen enriched air is also directed into the reactor vessel and the reforming temperature is preferably between about 550° C. and about 900° C. The catalyst bed and/or reactor vessel feeds can be heated to the selected reforming reaction temperature with the heat generating means described herein.

The reforming reaction converts the reactor feeds to a hydrogen-rich reformate and a fixed carbon dioxide. Hydrogen-rich reformate is continuously removed from the catalyst bed and reactor vessel as it is produced. The hydrogen-rich reformate can optionally be directed to a polishing unit to remove one or more impurities from the reformate and/or directed to hydrogen storage or use. When the carbon dioxide fixing material is effectively fixing carbon dioxide, the hydrogen-rich reformate exiting the reactor vessel comprises greater than about 90%, preferably greater than about 95%, more preferably greater than about 96%, and still more preferably greater than about 97% hydrogen by volume. Further, where the hydrocarbon fuel comprises natural gas, the reformate comprises less than about 1% methane and less than about 1% combined of carbon monoxide and carbon dioxide. More specifically, the concentration of carbon monoxide in the hydrogen-rich reformate is less than about 50 ppm, preferably less than about 25 ppm, more preferably less than about 10 ppm, and still more preferably less than about 5 ppm.

In some embodiments, one or more components of the intermediate reformate can be monitored so as to detect a change in reformate composition that would indicate at least partial saturation of the carbon dioxide fixing material. When fixed carbon dioxide is to be released from the carbon dioxide fixing material, the flow of hydrocarbon fuel and steam is reduced so as to interrupt the reforming reaction. In an optional but highly preferred embodiment, the reactor vessel is purged with a small volume of high temperature steam prior to calcinating the carbon dioxide fixing material. Between about 1 and about 5 reactor volumes of steam should be used for purposes of purging the reactor. Although referred to as “high temperature”, the temperature of this purge steam should be at least about the reforming reaction temperature.

During the reforming reaction, the carbon dioxide fixing material fixes carbon dioxide in the reformate to provide a hydrogen-rich reformate and fixed carbon dioxide. Where the carbon dioxide fixing material is calcium oxide, the fixed carbon dioxide is in the form of calcium carbonate. As used herein, the term “calcine” and its derivatives are intended to refer to those reactions or processes wherein a carbon dioxide fixing material is heated to a temperature at which fixed carbon dioxide is released due to thermal decomposition, phase transition or some other physical or chemical mechanism. As such, a temperature at which fixed carbon dioxide is released is referred herein to as a “calcination temperature”. In a preferred embodiment, the calcination temperature for the carbon dioxide fixing material will be above the reforming reaction temperature. More specifically, the calcination temperature of the fixing material will be above about 550° C., preferably above about 650° C., and more preferably above about 750° C. Although not to be construed as limiting of suitable carbon dioxide fixing materials, a preferred calcination reaction has the equation:
CaCO₃→CO₂+CaO(calcination) (V).

Heat required to raise the temperature of the carbon dioxide fixing material to a calcination temperature can be provided by heat exchanging means as described herein, but such heat is preferably generated by an oxidation reaction within the reactor vessel. In a preferred embodiment, the oxidation reaction occur external to the catalyst bed within a separate oxidation zone. Oxidant is directed into the oxidation zone, preferably through an oxidant inlet, such as a burner nozzle, in such a manner that the oxidant mixes and reacts with hydrocarbon fuel. An ignition source such as a spark plug or the like is preferably used to initiate the oxidation reaction. Preferably, the hydrocarbon fuel is oxidized non-catalytically.

The temperature of the oxidation reaction and the heated oxidation products can be adjusted by adjusting the fuel and oxidant feed streams. However, it is preferred that a temperature moderator be directed into the oxidation zone to control the oxidation reaction and the temperature of the heated oxidation products. Suitable temperature moderators can include a fluid material selected from the group consisting of steam, water, air, oxygen-depleted air, carbon dioxide, nitrogen or mixtures of the same.

As the temperature of the carbon dioxide fixing material reaches a calcination temperature, fixed carbon dioxide is liberated from the fixing material and is removed from the catalyst bed as a carbon dioxide-laden gas. In some embodiments, the carbon dioxide laden-gas is removed from the vessel by the flow of the heated oxidation products that pass through the catalyst bed. In other embodiments, the carbon dioxide-laden gas can be removed by passing a small volume of a sweep stream through the bed. Suitable sweep streams may comprise steam, air, oxygen-depleted air, carbon dioxide, inert gases such as nitrogen, and mixtures of the same. In an alternative, the expansion of carbon dioxide as it evolves from the carbon dioxide fixing material may be sufficient to cause the carbon dioxide-laden gas to flow from the catalyst bed.

The composition of the carbon dioxide-laden gas removed from the catalyst bed can be monitored to determine when a desired level of carbon dioxide has been liberated. When such a level is detected, the oxidation reaction is interrupted and the catalyst bed is allowed to cool to a reforming temperature before resuming the reforming reaction. The cooling of the catalyst bed can occur through radiation cooling or through the use of heat exchanging means within the catalyst bed. In an optional but highly preferred embodiment, the reactor vessel is purged with a small volume of high temperature steam before resuming the reforming reaction. The volume of steam is between about 1 and about 5 reactor volumes although greater volumes of steam can be used. Although referred to as “high temperature”, the temperature of this optional purge steam should approximate the reforming reaction temperature. When the reactor vessel is optionally purged in this manner following the oxidation reaction, the catalyst bed can be rapidly cooled to a reforming temperature without the use of heat transfer devices.

Repeated reforming/calcination cycles tend to decrease the fixing capacity of carbon dioxide fixing materials and thereby reduce hydrocarbon to hydrogen conversion rates. In an effort to minimize losses in carbon dioxide fixing capacity, it has been found that hydration of the carbon dioxide fixing material between one or more cycles can sustain the fixing capacity of such materials at acceptable levels over multiple cycles. Hydration of fixing materials has also been found to provide improvements in reaction efficiencies for both the conversion rate of hydrocarbon fuel to hydrogen and the shift conversion of carbon monoxide to hydrogen and carbon dioxide.

Hydration of the calcinated carbon dioxide fixing material can be scheduled to be performed at virtually any time, including but not limited to, after each calcination step, during reactor start-up and/or shut-down procedures, and after the performance of a number of reforming/calcination cycles. In addition, hydration can be triggered by monitoring and detecting an undesirable change in reformate composition. By way of example, hydration can be triggered when the level of a monitored reformate component exceeds or falls below a predetermined level that is indicative of when the fixing capacity of the carbon dioxide fixing material has been impaired. The reformate components that can be monitored for this purpose include, but are not limited to, hydrogen, carbon monoxide, carbon dioxide, and unreacted hydrocarbon fuel.

Hydration can be achieved by contacting calcinated carbon dioxide fixing material with water, preferably in the form of steam. After calcination, the catalyst bed is at an elevated temperature relative to reforming temperatures. Hydration is preferably conducted at a hydration temperature that is below the calcination temperature, and preferably below the reforming temperature. Hydration temperatures should be less than 600° C., preferably below about 500° C., more preferably below about 400° C. and even more preferably below about 300° C. For instance, sufficient hydration can be achieved by passing steam at 200° C. through the catalyst bed.

Not to be bound by theory, but in embodiments where the carbon dioxide fixing material is calcium oxide, repeated cycles of fixing/calcinating carbon dioxide tends to compact the calcium oxide and form crystalline-like structures. Through hydration, at least a portion of the calcium oxide is converted with steam to calcium hydroxide. The formation of calcium hydroxide within the catalyst bed tends to break up the compacted and crystalline-like structures increasing the surface area of calcium oxide available for carbon dioxide fixing in subsequent cycles.

The amount of steam that is needed to achieve sufficient hydration will vary depending on the volume of the catalyst bed, the surface area of the carbon dioxide fixing materials within the bed, the type of fixing material used, the structure or matrix of catalyst(s) and fixing materials within the bed and the flow rate of steam through the bed. Where the fixing material comprises calcium oxide, sufficient steam should be passed through the catalyst bed to convert at least about 10% of the calcium oxide to calcium hydroxide to achieve the desired effect. More specifically, at least about 0.03 kg of steam per kg of calcium oxide is needed to achieve sufficient hydration. Greater quantities of steam may be needed where flow rates are higher. A more detailed description of the hydration of carbon dioxide fixing materials may be obtained by reference to U.S. patent application Ser. No. ______, entitled “Absorption Enhanced Reforming With Hydration Of Carbon Dioxide Fixing Material”, by Stevens et al., filed on April ______, 2004 (Attorney Docket No. X-0137), the description of which is incorporated herein by reference.

When the carbon dioxide fixing material is hydrated with steam prior to resuming the reforming reaction, the temperature of the catalyst bed will typically be lowered below the reforming reaction temperature. As such, the catalyst bed may need to be heated to the reforming reaction temperature prior to resuming the reforming reaction.

### DETAILED DESCRIPTION OF THE FIGURES

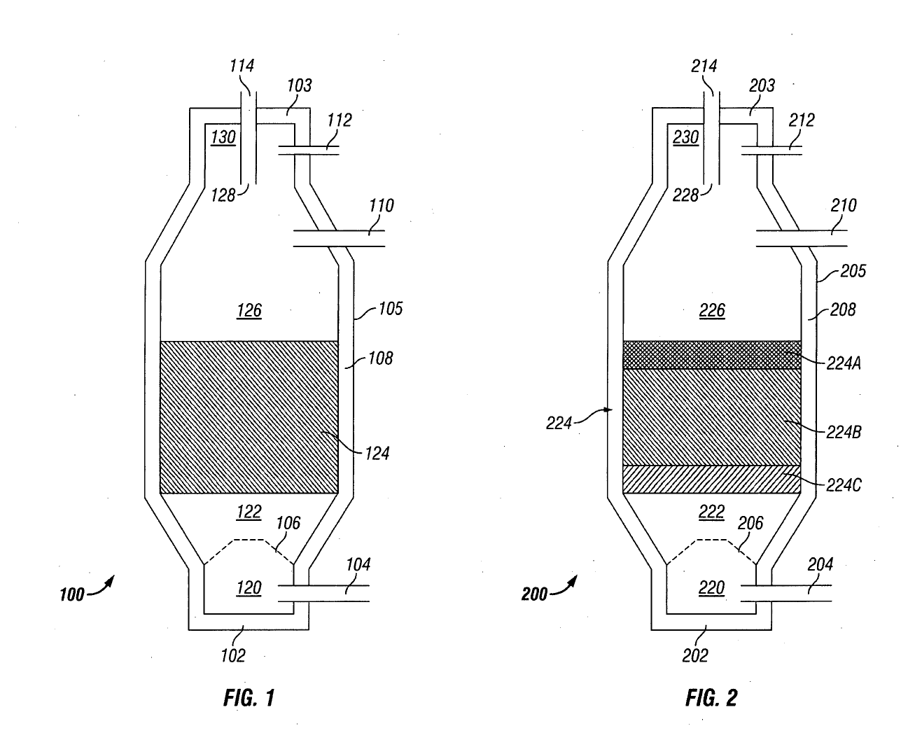

FIG. 1 illustrates reactor 100 of the instant invention comprising reactor vessel 105. Reactor vessel 105 comprises bottom wall 102, side wall 108 and top wall 103. Outlet 104 is provided in the lower portion of reactor vessel 105 for removing a hydrogen-rich reformate from the vessel. Inlet 112 is provided in the upper portion of the reactor vessel for receiving a hydrocarbon fuel, steam or a mixture of hydrocarbon fuel and steam for use in the reforming reaction. Disposed within vessel 105 is catalyst bed 124 that comprises reforming catalyst, carbon dioxide fixing material and optional water gas shift catalyst. Catalyst bed support materials 122, consisting of inert materials and gas permeable support member 106 spanning the lower portion of vessel 105, provide support to the catalyst bed. “Upstream” and “downstream” are used herein in reference to the direction of flow of the hydrocarbon fuel when the reactor vessel is being used to convert the hydrocarbon fuel to a hydrogen-rich reformate. As shown in FIG. 1, hydrocarbon fuel is introduced into upper portion 130 of reactor vessel 105 through inlet 112. When the reactor is converting the hydrocarbon fuel to hydrogen rich reformate, the hydrocarbon fuel flows down through the oxidation zone 126 and into catalyst bed 124 where it is converted to a hydrogen-rich reformate. Carbon dioxide formed during the conversion reaction is fixed by the carbon dioxide fixing material within catalyst bed 124. The hydrogen-rich reformate flows out of the catalyst bed and through support materials 122 into lower portion 120 of the reactor vessel. The hydrogen rich reformate is removed from the reactor vessel through outlet 104. A manifold (not shown) connected to outlet 104 can be used to direct the hydrogen-rich reformate to downstream polishing unit, storage, or end use.

Oxidation zone 126 is disposed within the reaction vessel upstream of catalyst bed 124. Oxidant inlet 114 is provided for directing an oxidant into oxidation zone 126. The oxidant mixes with hydrocarbon fuel near outlet 128 of oxidant inlet 114. The mixture of oxidant and hydrocarbon fuel is ignited by an ignition source (not shown) so that they react to produce heated oxidation products. Moderator inlet 110 is provided for directing a fluid temperature moderator into the oxidation zone. The temperature moderator is used to control the oxidation reaction within oxidation zone 126 so that the temperature of the heated oxidation products is not excessive. The heated oxidation products of the oxidation reaction flow down through the catalyst bed to heat the carbon dioxide fixing material within the catalyst bed. The carbon dioxide fixing material is thereby heated to a calcination temperature so that fixed carbon dioxide is released. The oxidation products and liberated carbon dioxide flow through support materials 122 and out of the reactor vessel through outlet 104. A manifold (not shown) connected to outlet 104 can be used to divert the carbon dioxide to a downstream vent or sequestration unit.

FIG. 2 illustrates reactor 200 of the instant invention comprising reactor vessel 205. Reactor vessel 205 is similar to reactor vessel 105 illustrated in FIG. 1. However as shown in FIG. 2, catalyst bed 224 comprises a plurality of reaction zones including inlet zone 224A, intermediate zone 224B and outlet zone 224C. Inlet zone 224A comprises a reforming catalyst but no carbon dioxide fixing material. Intermediate zone 224B comprises reforming catalyst, a water gas shift catalyst and a carbon dioxide fixing material and outlet zone 224C comprises carbon dioxide fixing material and water gas shift catalyst, but no reforming catalyst. Within catalyst bed 224, carbon dioxide produced in inlet zone 224A and intermediate zone 224B is fixed by the carbon dioxide fixing materials in intermediate zone 224B and outlet zone 224C.

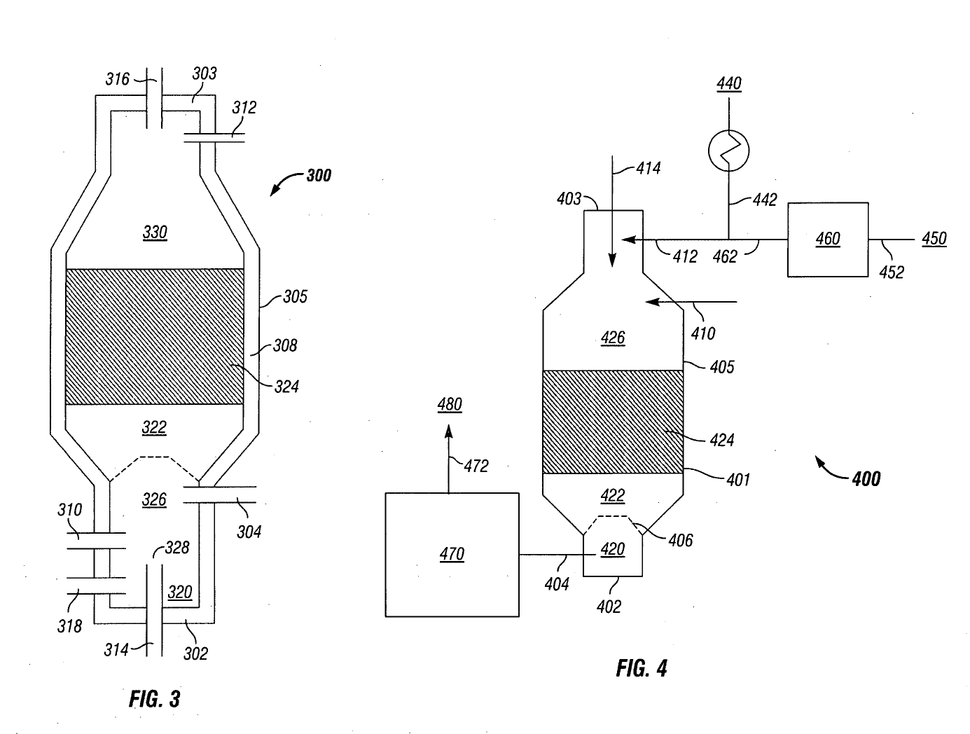

FIG. 3 illustrates reactor 300 of the instant invention comprising reactor vessel 305. Reactor vessel 305 comprises bottom wall 302, side wall 308 and top wall 303. Outlet 304 is provided in the lower portion of reactor vessel 305 for removing a hydrogen-rich reformate from the vessel. Inlet 312 is provided in the upper portion of the reactor vessel for receiving a hydrocarbon fuel, steam or a mixture of hydrocarbon fuel and steam for use in the reforming reaction. Disposed within vessel 305 is catalyst bed 324 that comprises reforming catalyst, carbon dioxide fixing material and optional water gas shift catalyst. Catalyst bed support materials 322 consisting of inert materials and gas permeable support member 306 spanning the lower portion of vessel 305, provide support to catalyst bed 324.

As shown in FIG. 3, hydrocarbon fuel is introduced into upper portion 330 of reactor vessel 305 through inlet 312. When the reactor is converting the hydrocarbon fuel to hydrogen rich reformate, hydrocarbon fuel flows down into catalyst bed 324 where it is converted to a hydrogen-rich reformate. Carbon dioxide formed during the conversion reaction is fixed by the carbon dioxide fixing material within catalyst bed 324. The hydrogen-rich reformate flows out of the catalyst bed and through support materials 322 into lower portion 320 of the reactor vessel. The hydrogen rich reformate is removed from the reactor vessel through outlet 304. A manifold (not shown) connected to outlet 304 can be used to direct the hydrogen-rich reformate to downstream polishing unit, storage, or end use.

Oxidation zone 326 is disposed within the reaction vessel downstream of catalyst bed 324. Oxidant inlet 314 is provided for directing an oxidant into oxidation zone 326. An oxidation fuel inlet 318 is also provided for directing a hydrocarbon oxidation fuel into oxidation zone 326. The oxidant mixes with the hydrocarbon oxidation fuel near outlet 328 of oxidant inlet 314. The mixture of oxidant and hydrocarbon oxidation fuel is ignited by an ignition source (not shown) so that they react to produce heated oxidation products. Moderator inlet 310 is provided for directing a fluid temperature moderator into the oxidation zone. The temperature moderator is used to control the temperature of the heated oxidation products produced in oxidation zone 326. Heat from the oxidation reaction radiates upward through reactor vessel 305 through support materials 322 and into catalyst bed to heat the carbon dioxide fixing material within the catalyst bed. Heat exchanging means (not illustrated) disposed within the lower portion of reactor vessel 305 transfer heat from the heated oxidation products in the oxidation zone to the catalyst bed. The carbon dioxide fixing material is heated to a calcination temperature so that the fixed carbon dioxide is released. A sweep stream is directed in to the upper portion of reactor vessel 305 through inlet 316 to sweep the liberated carbon dioxide and oxidation products out of the reactor vessel through outlet 304. A manifold (not shown) connected to outlet 304 can be used to divert the carbon dioxide to a downstream vent or sequestration unit.

FIG. 4 illustrates apparatus 400 for use in generating hydrogen. Apparatus 400 includes reactor 401, desulfurization unit 460 for providing a desulfurized hydrocarbon fuel to reactor 401, and polishing unit 470 disposed downstream from reactor 401 for further polishing the hydrogen-rich reformate produced in the reactor. More specifically, sulfur-containing hydrocarbon fuel 452 derived from source 450 is directed into desulfurization unit 460. The desulfurization unit removes the sulfur-containing compounds from the fuel and directs desulfurized fuel 462 to reactor 401. Prior to being directed into reactor vessel 405 desulfurized fuel 462 is combined and mixed with steam 442. The mixture 412 of desulfurized fuel and steam is directed into the upper portion of reactor vessel 405 and is then directed into catalyst bed 424 where it is converted to a hydrogen-rich reformate and fixed carbon dioxide. The hydrogen-rich reformate is directed out of the reactor vessel through outlet 404 to polishing unit 470. Polishing unit 470, comprises a methanation reactor that converts the low levels of carbon oxides remaining in the hydrogen-rich reformate to methane, which does not have a deleterious effect on many catalysts such as are used in fuel cells and in chemical and petroleum refining operations. The hydrogen-rich reformate 472 leaving the methanation reactor 470 is then directed to hydrogen storage or end use 480. Although not illustrated in FIG. 4, a manifold intermediate between reactor 401 and polishing unit 470 is used to divert hydrogen-rich reformate to polishing unit 470 and liberated carbon dioxide to vent or sequestration.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

1. A reforming reactor for producing a hydrogen reformate, the reactor comprising
a reactor vessel having an inlet for receiving a hydrocarbon fuel and an outlet for delivering a hydrogen-rich reformate;
a catalyst bed disposed within the reactor vessel, wherein the catalyst bed comprises a reforming catalyst and a carbon dioxide fixing material;
an oxidation zone disposed within the reactor vessel proximate the catalyst bed, the oxidation zone in fluid communication with the catalyst bed; and
a moderator inlet for introducing a temperature moderator into the oxidation zone.

2. The reactor of claim 1, wherein the catalyst bed further comprises a water gas shift catalyst.

3. The reactor of claim 1, further comprising an oxidant inlet for directing an oxidant into the oxidation zone.

4. The reactor of claim 1, further comprising catalyst bed support means for supporting the catalyst bed within the reactor vessel.

5. The reactor of claim 1, wherein the reactor vessel comprises a side wall comprising a refractory material.

6. The reactor of claim 1, wherein the catalyst bed has a non-uniform distribution of the reforming catalyst and carbon dioxide fixing material.

7. An apparatus for generating a hydrogen-rich reformate comprising:
a desulfurization unit for removing sulfur-containing compounds from a hydrocarbon fuel;
a reactor in fluid communication with the desulfurization unit for receiving the desulfurized hydrocarbon fuel and producing a hydrogen-rich reformate, the reactor comprising a reactor vessel having an inlet for receiving a hydrocarbon fuel and an outlet for delivering a hydrogen-rich reformate, a fixed catalyst bed disposed within the reactor vessel, wherein the catalyst bed comprises a reforming catalyst and a carbon dioxide fixing material, an oxidation zone disposed within the reactor vessel proximate the catalyst bed, the oxidation zone in fluid communication with the catalyst bed, and a moderator inlet for introducing a temperature moderator into the oxidation zone; and
a polishing unit in fluid communication with the reactor vessel, the polishing unit disposed downstream from the reactor vessel for removing one or more impurities from the hydrogen-rich reformate.

8. The apparatus of claim 7, wherein the polishing unit is selected from the group consisting of drying units, methanation reactors, selective oxidation reactors, pressure swing absorption units, temperature swing absorption units, membrane separators and combinations of thereof.

9. A reforming reactor for producing a hydrogen reformate, the reactor comprising
a reactor vessel having an inlet for receiving a hydrocarbon fuel and an outlet for delivering a hydrogen-rich reformate;
a fixed catalyst bed disposed within the reactor vessel, wherein the catalyst bed comprises a reforming catalyst and a carbon dioxide fixing material; and
an oxidation zone disposed within the reactor vessel downstream of the catalyst bed, the oxidation zone in fluid communication with the catalyst bed.

10. The reactor of claim 9, wherein the catalyst bed further comprises a water gas shift catalyst.

11. The reactor of claim 9, further comprising an oxidant inlet for directing an oxidant into the oxidation zone.

12. The reactor of claim 9, further comprising a moderator inlet for introducing a temperature moderator into the oxidation zone.

13. The reactor of claim 9, further comprising catalyst bed support means for supporting the catalyst bed within the reactor vessel.

14. The reactor of claim 9, wherein the reactor vessel comprises a side wall comprising a refractory material.

15. The reactor of claim 9, wherein the catalyst bed has a non-uniform distribution of the reforming catalyst and carbon dioxide fixing material.

16. The reactor of claim 9, further comprising heat exchanging means disposed within the reactor for exchanging heat between the catalyst bed and the oxidation zone.

17. An apparatus for generating a hydrogen-rich reformate comprising:
a desulfurization unit for removing sulfur-containing compounds from a hydrocarbon fuel;
a reactor in fluid communication with the desulfurization unit for receiving the desulfurized hydrocarbon fuel and producing a hydrogen-rich reformate, the reactor comprising a reactor vessel having an inlet for receiving a hydrocarbon fuel and an outlet for delivering a hydrogen-rich reformate, a fixed catalyst bed disposed within the reactor vessel, wherein the catalyst bed comprises a reforming catalyst and a carbon dioxide fixing material, and an oxidation zone disposed within the reactor vessel downstream of the catalyst bed, the oxidation zone in fluid communication with the catalyst bed; and
a polishing unit in fluid communication with the reactor vessel, the polishing unit disposed downstream from the reactor vessel for removing one or more impurities from the hydrogen-rich reformate.

18. The apparatus of claim 17, wherein the polishing unit is selected from the group consisting of drying units, methanation reactors, selective oxidation reactors, pressure swing absorption units, temperature swing absorption units, membrane separators and combinations thereof.

19. A method for producing a hydrogen-rich reformate in a reactor having a catalyst bed comprising a reforming catalyst and carbon dioxide fixing material, the method comprising the steps of:
converting a hydrocarbon fuel over the catalyst bed to a reformate comprising hydrogen and carbon dioxide, the carbon dioxide fixing material fixing at least a portion of the carbon dioxide in the reformate to provide a hydrogen-rich reformate and fixed carbon dioxide;
removing hydrogen-rich reformate from the catalyst bed;
oxidizing a hydrocarbon fuel with an oxidant within the reactor to produce heated oxidation products;
adjusting the temperature of the heated oxidation products with a flow of a temperature moderator; and
heating the carbon dioxide fixing material with the heated oxidation products to a temperature at which at least a portion of the fixed carbon dioxide is released to provide a carbon dioxide-laden gas and heated carbon dioxide fixing material.

20. The method of claim 19, further comprising the step of removing sulfur from the hydrocarbon fuel prior to converting the hydrocarbon fuel to a reformate.

21. The method of claim 19, wherein the hydrocarbon fuel is converted with steam over the catalyst bed to reformate.

22. The method of claim 19, wherein the hydrocarbon fuel is converted to a hydrogen-rich reformate at a steam reforming temperature between about 400° C. and about 800° C.

23. The method of claim 19, wherein the catalyst bed is purged with steam after removing the hydrogen-rich reformate from the catalyst bed.

24. The method of claim 19, wherein the temperature moderator is a fluid selected from the group consisting of steam, water, air, carbon dioxide, nitrogen and mixtures of thereof.

25. The method of claim 19, wherein the carbon dioxide fixing material is heated to a temperature between about 500° C. and about 900° C.

26. The method of claim 25, further comprising the step of interrupting the oxidation of the oxidant.

27. The method of claim 19, wherein the oxidant and the hydrocarbon fuel are oxidized non-catalytically.

28. The method of claim 19, further comprising the step of removing carbon dioxide-laden gas from the reactor vessel.

29. The method of claim 28, further comprising the step of purging the catalyst bed with steam after removing the carbon dioxide laden gas from the catalyst bed.

30. The method of claim 28, further comprising the step of resuming the conversion of the hydrocarbon fuel to reformate.

31. The method of claim 19, further comprising the step of hydrating the heated carbon dioxide fixing material with steam.

32. The method of claim 28, wherein the steam comprises a low temperature steam having a temperature below about 500° C.

33. The method of claim 19, further comprising the step of directing the hydrogen-rich reformate to a polishing unit selected from the group consisting of drying units, methanation reactors, selective oxidation reactors, pressure swing absorption units, temperature swing absorption units, membrane separators and combinations thereof.
